(19) United States
(12) Patent Application Publication
(10) Pub. No.: US 2024/0148194 A1
(43) Pub. Date: May 9, 2024

(54) Cutting board/slicer that can be operated with one hand to assist the disabled in the kitchen

(71) Applicant: Brandon Ray Burchfield, Mobile, AL (US)

(72) Inventor: Brandon Ray Burchfield, Mobile, AL (US)

(21) Appl. No.: 18/046,880

(22) Filed: Nov. 7, 2022

(51) Int. Cl. A47J 47/00

(52) U.S. Cl. CPC A47J 47/005

(57) ABSTRACT

A cutting board/slicer that can be operated with only one hand/arm for handicap or disabled use is disclosed. All parts of the newly designed cutting board system can be assembled and disassembled with the use of just one hand/arm. The cutting board base is designed to mount to a fixable desired working surface via suction system, magnetic latching, or silicone sticky pad which allows user to apply force from the food to the blade to perform cuts or grating function. Other cutting board systems must be held with one hand to secure the board so force can be applied to make cuts where this new system resolves this problem. Assembly and disassembly of existing cutting boards/slicers on the market require both arms and hands to complete this function with ease but the newly designed system allows handicap or disabled users to complete these functions with much greater ease.

### BACKGROUND OF THE INVENTION

Problem Solved: Handicap individuals often want to cook but one arm or one-handed operation of manual cutting boards or slicers/graters are not easy or near impossible to use as force needs to be applied against the slicer blade or grated which will move the device base and not allow the food product to be sliced or grated through the blade. Also, the assembly and disassembly of most cutting board systems require two hands to do these operations easily.

Other cutting board systems must be held with one hand to secure the board so force can be applied to make cuts. Assembly and disassembly of existing cutting boards on the market require both arms and hands to complete this function with ease.

All parts of the newly designed cutting board system can be assembled and disassembled with the use of just one hand/arm. The cutting board base is designed to mount fixable to desired working surface via suction system, magnetic latching, or silicone sticky pad which allows user to apply force from food to the blade to perform cuts or grating function. Other cutting board systems must be held with one hand to secure the board so force can be applied to make cuts where this new system resolves this problem. Assembly and disassembly of existing cutting boards on the market require both arms and hands to complete this function with ease but the newly designed system allows handicap users to complete these functions with greater ease.

### DETAILED DESCRIPTION OF THE INVENTION

As stated above, Handicap individuals often want to cook but one arm or one-handed operation of manual cutting boards or slicers/graters are not easy or near impossible to use as force needs to be applied against the slicer blade of grater which will move the device base and not allow the food product to be sliced or grated through the blade. Also, the assembly and disassembly of most cutting board systems require two hands to do these operations easily. The invention claimed here solves this problem.

All parts of the newly designed cutting board system can be assembled and disassembled with the use of just one hand/arm. The cutting board base is designed to mount fixable to desired working surface via suction system, magnetic latching, or silicone sticky pad which allows user to apply force from food to the blade to perform cuts or grating function.

The claimed invention differs from what currently exists. All parts of the newly designed cutting board system can be assembled and disassembled with the use of just one hand/arm. The cutting board base is designed to mount fixable to desired working surface via suction system, magnetic latching, or silicone sticky pad which allows user to apply force from food to the blade to perform cuts or grating function. Other cutting board systems must be held with one hand to secure the board so force can be applied to make cuts where this new system resolves this problem. Assembly and disassembly of existing cutting boards on the market require both arms and hands to complete this function with ease but the newly designed system allows handicap users to complete these functions with much greater ease.

This invention is an improvement on what currently exists. All parts of the newly designed cutting board system can be assembled and disassembled with the use of just one hand/arm. The cutting board base is designed to mount fixable to desired working surface via suction system, magnetic latching, or silicone sticky pad which allows user to apply force from food to the blade to perform cuts or grating function. Other cutting board systems must be held with one hand to secure the board so force can be applied to make cuts where this new system resolves this problem. Assembly and disassembly of existing cutting boards on the market require both arms and hands to complete this function with ease but the newly designed system allows handicap users to complete these functions with much greater ease.

It is not easy for handicap users of existing cutting board products to operate and perform cutting food or assembly and disassembly and cleaning functions because most products require the use of both hands due to locking mechanisms or just the difficulty to secure the cutting board during operation.

All parts of the newly designed cutting board system can be assembled and disassembled with the use of just one hand/arm. The cutting board base is designed to mount fixable to desired working surface via suction system, magnetic latching, or silicone sticky pad which allows user to apply force from food to the blade to perform cuts or grating function. Other cutting board systems must be held with one hand to secure the board so force can be applied to make cuts where this new system resolves this problem. Assembly and disassembly of existing cutting boards on the market require both arms and hands to complete this function with ease but the newly designed system allows handicap users to complete these functions with much greater ease.

The Version of The Invention Discussed Here Includes:
1. Sticky silicone pad/magnet/suction cup
2. Lip handle
3. Mounting tray
4. Slide rail lips
5. Slide track
6. Cutting board
7. Food catch container
8. Blade holder assembly
9. Blade
10. Lip handle
11. Blade retainer assembly slots
12. Blade assembly removal finger slot
13. Convex divot spheres
14. Blade retention plastic post
15. Concave divots

Relationship Between The Components:

Cutting board (6) with slide tracks (5) on the bottom side of the cutting board (6) for slide mounting of the base mounting tray (3) for holding extra cutting blade assemblies (8)(9) and a slide track (5) area under the blade assembly (8)(9) for slide mounting of the food catch container (7). Base mounting tray (3) also slides onto the bottom of the cutting board (6) and has optional suction cups (1) or magnets (1) for mounting to table or counter. Blade assembly (8)(9) removable but fixed to an opening of the cutting board (6) near one end of the cutting board (6). Blade assembly (8)(9) is comprised of a blade holder (8) and blade (9) used for cutting, slicing, or grating food. A food catch container (7) is slide mounted on the bottom side of the cutting board (6) directly under the blade assembly (8)(9) to catch the food. The mounting tray (3) and the food catch container (7) both have protruding lip handles (10) and divots (13)(15) for catch locking of the base mounting tray (3) and the food catch container (7) to keep them secure in position.

How The Invention Works:

The cutting board mounting base tray mounts to a flat surface with suction cups on the bottom of the base mounting tray. The cutting board is slid onto the base mounting tray until divots lock into place securing the cutting board to the base mounting tray. The blade assembly is placed into the through hole of the cutting board and rest in position. The food catch container is slid into the slide tracks under the blade assembly on the bottom side of the cutting board. Because the base mounting tray is fixed to the counter or table via suction system, magnetic latching, or silicone sticky pad, the user can operate this device with the use of only one hand. All parts assembly and disassembly can be done with the use of only one hand.

How To Make The Invention:

Assemble cutting board as described to table or counter and slide food across blade. All elements are necessary. For mounting the base mounting tray there is optional use of suction cups, magnets, or sticky silicone pad depending on what the surface smoothness is to which the tray is being mounted.

The Base mounting tray could have many optional mounting elements for fixing it to a counter or table and would be understood to anyone skilled in the art.

How to Use the Invention:

To use this device one need only assemble the device as described and it can be used with the use of only one hand such as for handicap people.

### DESCRIPTION OF THE DRAWING

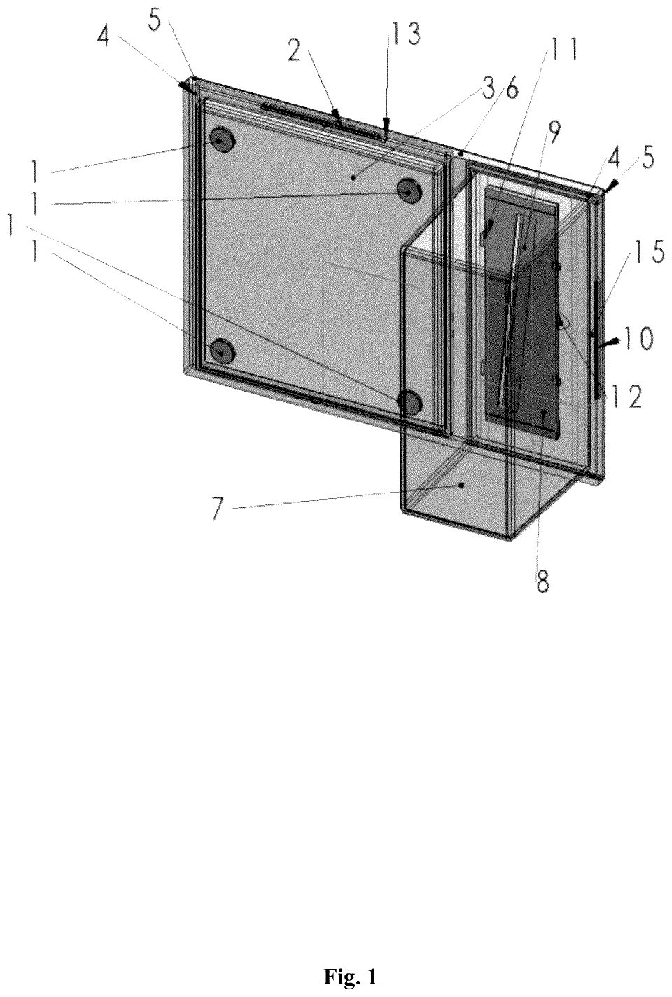

1. A food grade cutting, slicing, grating board comprised of all parts operable by use of only one hand operations.
A. The cutting board (6) of FIG. 1 is comprised of a material such as food grade plastic or wood.
B. The cutting board (6) of FIG. 1 comprised of four main parts such as the main body cutting board (6), the mounting tray (3), a food catch container (7), and a blade assembly (8)(9), which all are removably attached/detached by the use of only one hand.

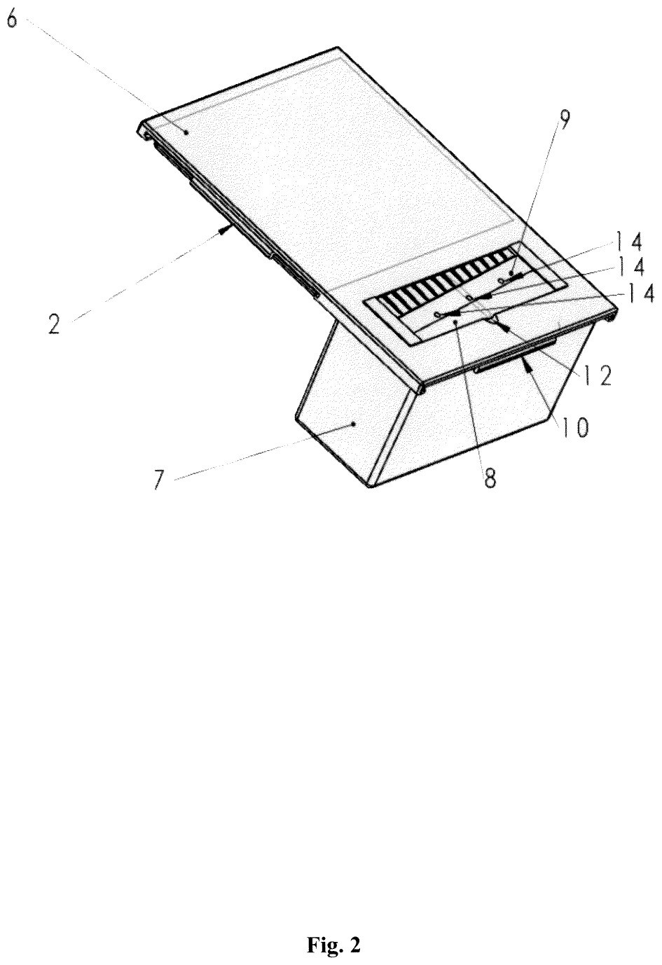

2. The main body cutting board (6) of FIG. 1 has two slide tracks (5) undercut sections that serve as a retaining groove that allow the mounting tray (3) and the food catch container (7) to slide in and out for functional access and removability of these parts.
A. The cutting board (6) of FIG. 1 has convex spheres (13) on the bottom surface of the cutting board (6) slide track (5) upper surfaces which serve the function of a flexible latch for the mounting tray (3) and the food catch container (7).
B. The main body cutting board (6) of FIG. 2 also having a rectangle cut vertically through on one end of the cutting board (6) about an inch away from end of the board. This empty pass-through rectangle hole is for the purpose of mounting the removable blade assembly (8)(9).

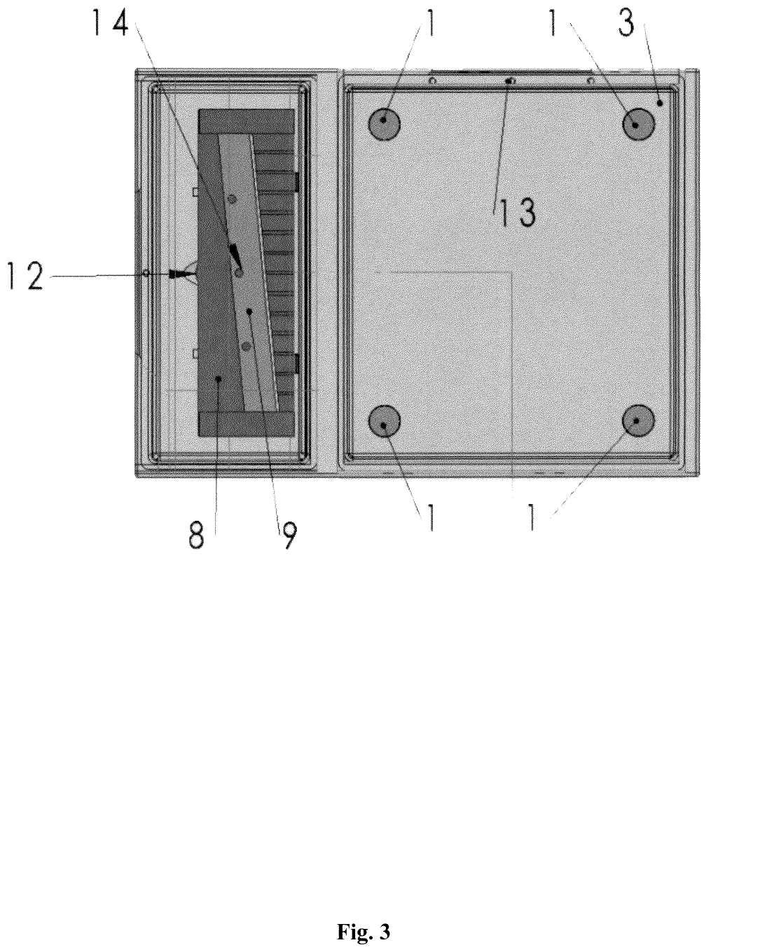

3. The mounting tray (3) of FIG. 3 comprised of a tray with a shallow inner area for holding and storing extra blade assemblies (8)(9), and which is able to be slidably attached to the lower bottom side of the cutting board (6) slide track (5) by having slide rail lips (4) protruding from two sides of the mounting tray (3) that slidably interconnected with slide track (5) of cutting board (6).
A. The mounting tray (3) of FIG. 3 comprised of flexibly removable suction cups, latching magnets, or silicone sticky pad (1) fixed mounted on the bottom of the mounting tray (3) in the four corners for mounting the mounting tray (3) to the surface of a counter or table.
B. The mounting tray (3) of FIG. 3 optionally having magnets (1) or silicone stick pads (1) in place of suction cups (1) for fixable mounting the mounting tray (3) to a metal table or counter surface.
C. The mounting tray (3) of FIG. 3 optionally having a sticky type of silicone (1) fixable mounted to the bottom surface for the purpose of friction sticky mounting the mounting tray (3) to the surface of a table or counter.
D. The mounting tray (3) of FIG. 1 has a protruding lip handle (2) on one outside edge of the mounting tray (3) that makes it easy to slide in and out and latches when slid in by the convex and concave divots (13)(15) on the mounting tray (3) and on the bottom side of the cutting board (6).

4. The food catch container (7) of FIG. 2 is slidably connected to the cutting board (6) and has an opening in the top of the container so that food that passes through the blade (9) can fall into the container for storage.
A. The food catch container (7) of FIG. 1 is slidably mounted to the cutting board (6) on the slide rail (5) on the underside of the cutting board (6), and the food catch container (7) has protruding lip rails (4) that slidably interconnect allowing the food catch container (7) to be removed with a one-handed operation.
B. The food catch container (7) of FIG. 1 has convex divot spheres (13) that when the container is closed the convex divot (13) mates with the concave divot (15) spheres of the cutting board (6) that serve as a flexible latching member. This forms a connection latch that can be released with minimal force by one-handed operation.
C. The food catch container (7) of FIG. 2 has a lip handle (10) protruding on one side of the container on the top outside edge so that it can be slid in and out easily with just one-handed operation.

5. The cutting blade assembly(8)(9) of FIG. 3 comprised of a blade (9) and a plastic blade retaining assembly (8) wherein the blade (9) is fixable mounted to the blade retaining assembly (8) where the blade has holes that allow plastic posts (14) that will be ultrasonically press welded to mushroom the head of the post to capture the blade (9) and become one unit that can be installed to the cutting board or removed from the cutting board with the ease of one-handed operation.

1. A food grade cutting, slicing, grating board comprised of all parts operable by use of only one hand operations.
A. The cutting board (6) of FIG. 1 is comprised of a material such as food grade plastic or wood.
B. The cutting board (6) of FIG. 1 comprised of four main parts such as the main body cutting board (6), the mounting tray (3), a food catch container (7), and a blade assembly (8)(9), which all are removably attached/detached by the use of only one hand.

2. The main body cutting board (6) of FIG. 1 has two slide tracks (5) undercut sections that serve as a retaining groove that allow the mounting tray (3) and the food catch container (7) to slide in and out for functional access and removability of these parts.
A. The cutting board (6) of FIG. 1 has convex spheres (13) on the bottom surface of the cutting board (6) slide track (5) upper surfaces which serve the function of a flexible latch for the mounting tray (3) and the food catch container (7).
B. The main body cutting board (6) of FIG. 2 also having a rectangle cut vertically through on one end of the cutting board (6) about an inch away from end of the board. This empty pass-through rectangle hole is for the purpose of mounting the removable blade assembly (8)(9).

3. The mounting tray (3) of FIG. 3 comprised of a tray with a shallow inner area for holding and storing extra blade assemblies (8)(9), and which is able to be slidably attached to the lower bottom side of the cutting board (6) slide track (5) by having slide rail lips (4) protruding from two sides of the mounting tray (3) that slidably interconnected with slide track (5) of cutting board (6).
A. The mounting tray (3) of FIG. 3 comprised of flexibly removable suction cups, latching magnets, or silicone sticky pad (1) fixed mounted on the bottom of the mounting tray (3) in the four corners for mounting the mounting tray (3) to the surface of a counter or table.
B. The mounting tray (3) of FIG. 3 optionally having magnets (1) or silicone stick pads (1) in place of suction cups (1) for fixable mounting the mounting tray (3) to a metal table or counter surface.
C. The mounting tray (3) of FIG. 3 optionally having a sticky type of silicone (1) fixable mounted to the bottom surface for the purpose of friction sticky mounting the mounting tray (3) to the surface of a table or counter.
D. The mounting tray (3) of FIG. 1 has a protruding lip handle (2) on one outside edge of the mounting tray (3) that makes it easy to slide in and out and latches when slid in by the convex and concave divots (13)(15) on the mounting tray (3) and on the bottom side of the cutting board (6).

4. The food catch container (7) of FIG. 2 is slidably connected to the cutting board (6) and has an opening in the top of the container so that food that passes through the blade (9) can fall into the container for storage.
A. The food catch container (7) of FIG. 1 is slidably mounted to the cutting board (6) on the slide rail (5) on the underside of the cutting board (6), and the food catch container (7) has protruding lip rails (4) that slidably interconnect allowing the food catch container (7) to be removed with a one-handed operation.
B. The food catch container (7) of FIG. 1 has convex divot spheres (13) that when the container is closed the convex divot (13) mates with the concave divot (15) spheres of the cutting board (6) that serve as a flexible latching member. This forms a connection latch that can be released with minimal force by one-handed operation.
C. The food catch container (7) of FIG. 2 has a lip handle (10) protruding on one side of the container on the top outside edge so that it can be slid in and out easily with just one-handed operation.

5. The cutting blade assembly(8)(9) of FIG. 3 comprised of a blade (9) and a plastic blade retaining assembly (8) wherein the blade (9) is fixable mounted to the blade retaining assembly (8) where the blade has holes that allow plastic posts (14) that will be ultrasonically press welded to mushroom the head of the post to capture the blade (9) and become one unit that can be installed to the cutting board or removed from the cutting board with the ease of one-handed operation.
